(19) United States
(12) Patent Application Publication
(10) Pub. No.: US 2010/0035714 A1
(43) Pub. Date: Feb. 11, 2010

(54) Flexible Bicycle Chain

(76) Inventors: Montanari Sandro, Formigine (IT); Righi Ermanno, Modena (IT)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/580,494

(22) Filed: Oct. 16, 2009

Related U.S. Application Data
(63) Continuation-in-part of application No. 11/776,552, filed on Jul. 12, 2007.

(51) Int. Cl. F16G 13/02

(52) U.S. Cl. 474/231

(57) ABSTRACT

A chain includes a plurality of inner links in which adjacent two are connected by an outer link. The inner link includes at least one first bushing mounted between the two inner plates and at least one roller mounted in the inner link, outer link and first bushing. The roller includes an engaging section which extends on its outer periphery thereof and in a curved shape with a uniform radial distance with respect to a center thereof. The first bushing includes a retaining section in which the engaging section of the roller moveably fits, and the first bushing and roller includes a gap defined therebetween so that the outer link is able to tilt together relative to the inner link.

### CROSS REFERENCE

The present application is a continuation-in-part application of U.S. patent application Ser. No. 11/776,552, filed on Jul. 12, 2007, of which the entire disclosure is incorporated herein.

### BACKGROUND OF THE INVENTION

1. Field of the Invention

The present invention relates to a chain and, in particular, to a chain which can be used in connection with a bicycle and which is configured to minimize deflecting movement occurred when shifting form one sprocket of the bicycle to another.

2. Description of the Related Art

FIG. 9 shows a chain 1 used in connection with sprockets 2, and the chain 1 would have a deflecting movement as it is shifted from one sprocket 2 to another.

Referring to WO 03/091599A1, a chain includes a plurality of inner links in which adjacent two are connected by an outer link. Each inner link includes two inner plates and at least one bushing connected therebetween. In addition, each outer link includes two outer plates to which the inner plates of the inner link are connected, and the two inner plates are sandwiched between the two outer plates. Specifically, the inner and outer links are connected by a roller inserting through the inner and outer plates and the bushing.

Although showing that the inner and outer links are able to tilt relative to each other as the roller is rotatable with respect to the bushing, it should be appreciated, however, the roller can not rotate with respect to the bushing.

As shown in FIG. 10, a chain 3 which is drawn in corresponding with the chain of WO 03/091599A1 includes an outer link 4 including two outer plates 6, an inner link 5 including two inner plates 7, a bushing 8 connected between the inner plates 7, and a roller 9 extending through the outer plates 6, the inner plates 7, and the bushing 8 to connect the outer 4 and inner 5 links. As shown in FIG. 11, if the outer 4 and inner 5 links are tilted relative to each other, the roller 9 would be expected to move in a radial path P1 with respect to point O, as the bushing 8 has a cambered interior edge with a radius of curvature with respect to point O. However, it is impossible to move the roller 6 as the roller 6 would be obstructed by the edge of the bushing 9.

Referring to U.S. Pat. No. 1,945,357, although showing a chain with outer and inner links being able to tilt relative to each other due to that a roller which connects the outer and inner links is rotatable with respect to a bushing of the inner link, it should be appreciated, however, it is difficult for the bushing to always maintain engagement in the middle of a longitudinal length of the roller so the outer link tilts clockwise and counterclockwise relative to the inner link in the same extent.

The present invention is, therefore, intended to obviate or at least alleviate the problems encountered in the prior art.

### SUMMARY OF THE INVENTION

According to the present invention, a chain includes at least one inner link including two inner plates being arranged oppositely and at least one outer link including two outer plates being arranged oppositely. The chain further includes at least one first bushing mounted between the two inner plates and at least one roller mounted in two inner plates, two outer plates and the first bushing. The roller includes an engaging section which extends in a plane transverse to its longitudinal length and outwardly from and circumferentially on its outer periphery thereof. Additionally, the engaging section extends in a curved shape with a uniform radial distance with respect to a center of the roller. The first bushing includes an inner periphery defining a retaining section in which the engaging section of the roller moveably fits, and the inner periphery is gapped from the outer periphery of the roller by a first gap so that the roller and the outer link are able to tilt together relative to the inner link, and with the center being a pivot on which the inner and outer link turn.

It is therefore an object of the present invention to provide a chain that overcomes the problem of the related prior art.

It is another object of the present invention to provide a chain which includes a plurality of inner links in which adjacent two are connected by an outer link.

It is yet another object of the present invention to provide a chain in which each of the inner links and each of the outer links are able to be tilted relative to each other.

Other objects, advantages, and new features of the present invention will become apparent from the following detailed description of the invention when considered in conjunction with the accompanied drawings

### BRIEF DESCRIPTION OF THE DRAWINGS

FIG. 1 is a perspective view of a chain in accordance with the present invention.

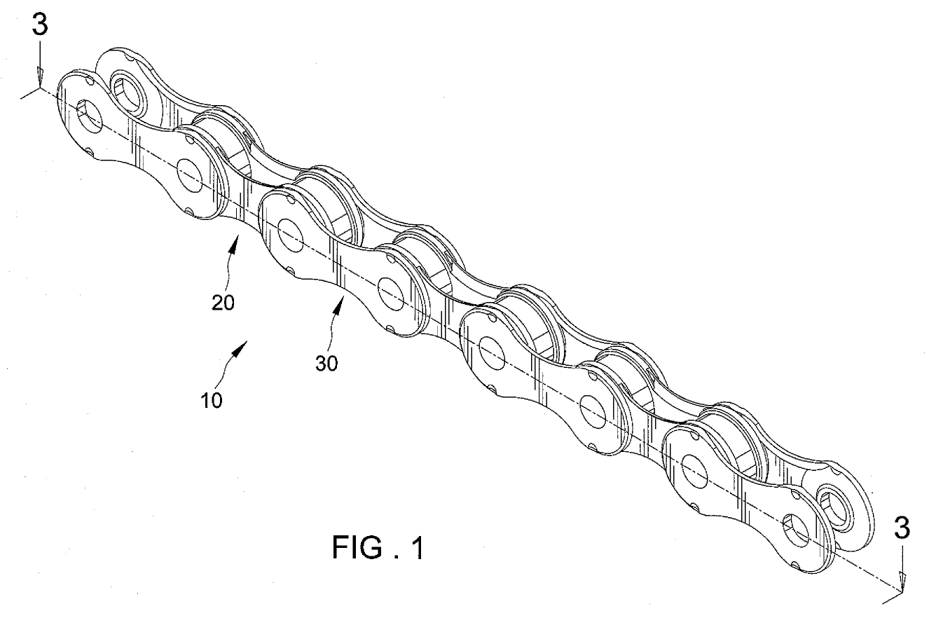

FIG. 2 is a partial, exploded perspective view of the chain of FIG. 1.

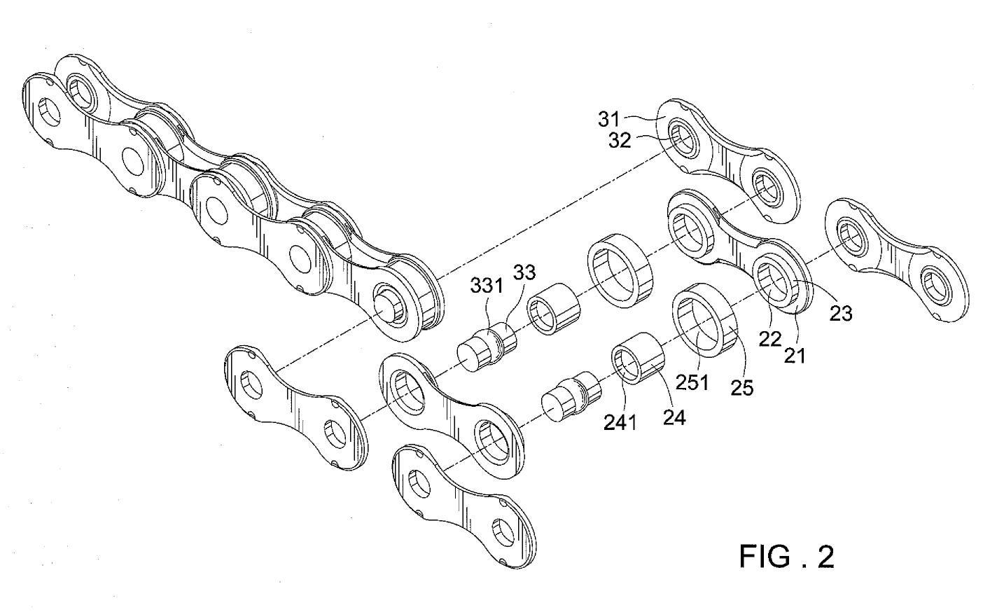

FIG. 3 is a cross-sectional view taken along line 3-3 of FIG. 1.

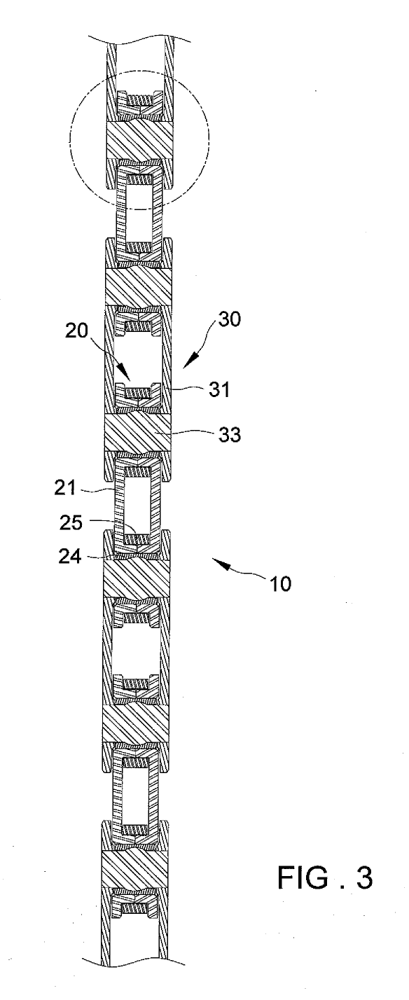

FIG. 4 is an enlarged cross-sectional view of FIG. 3.

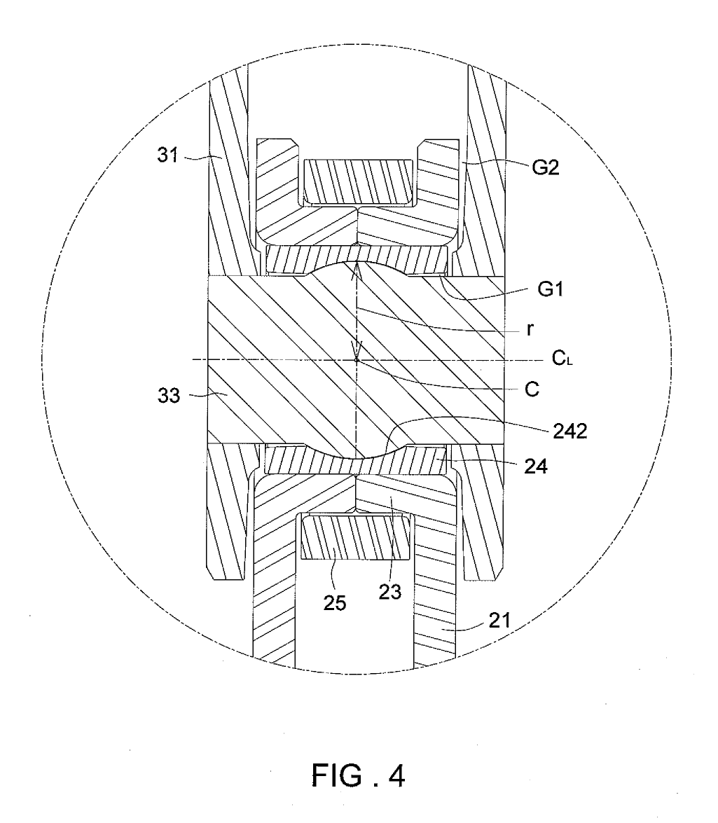

FIG. 5 is a cross-sectional view showing each inner link of the chain being adapted to be tilted with respect to an outer link connected thereto.

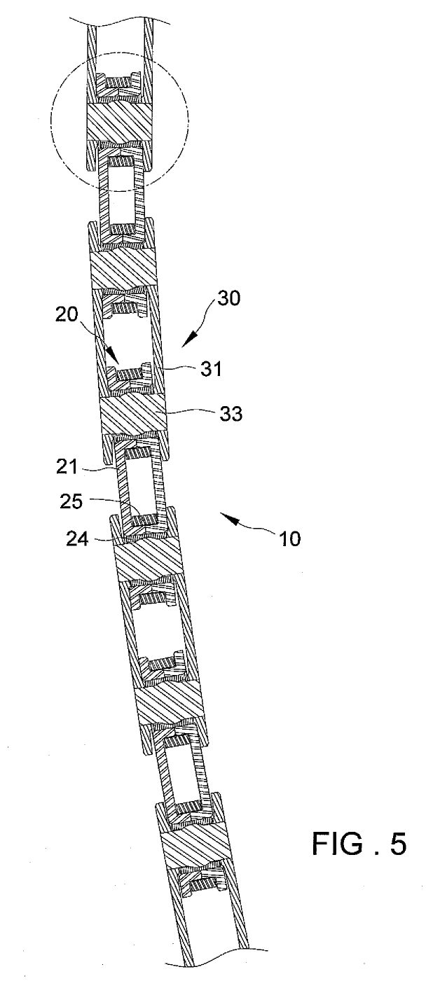

FIG. 6 is an enlarged cross-sectional view of FIG. 5.

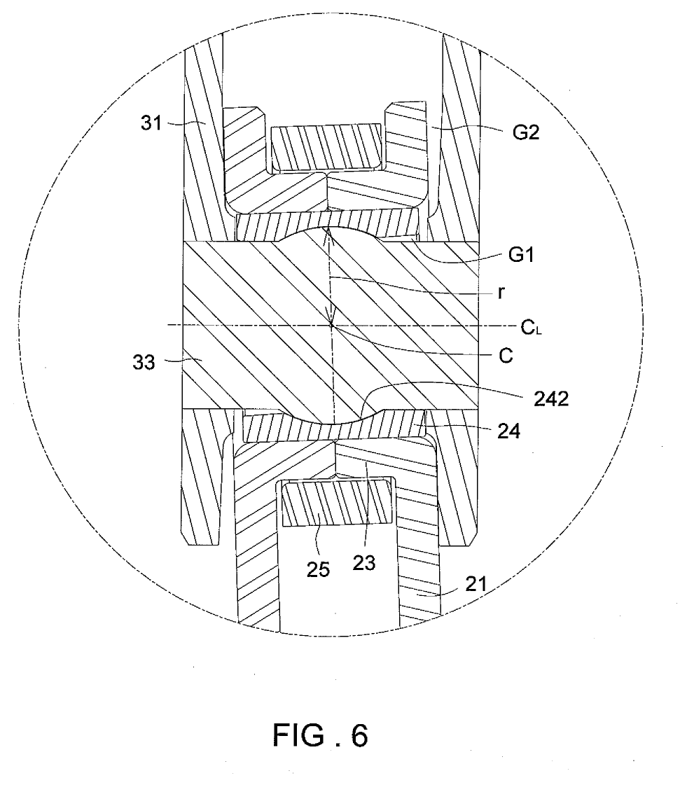

FIG. 7 is a schematic view showing the chain embodying the present invention being adapted to engage with a sprocket.

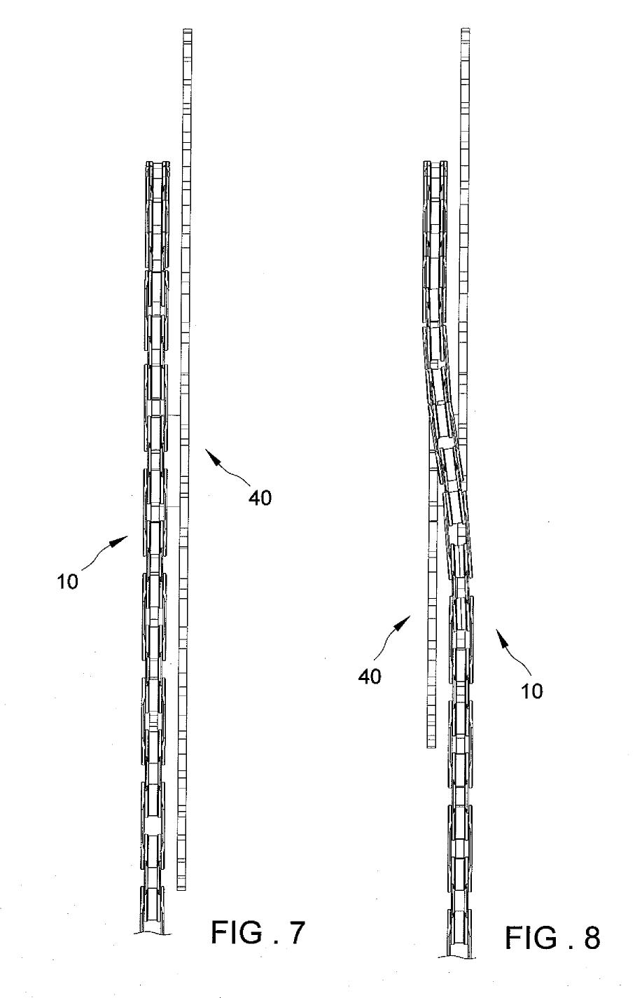

FIG. 8 is a schematic view showing the chain embodying the present invention being adapted to shift from one sprocket to another with minimum deflecting movement of the chain.

FIG. 9 is a cross-sectional view of a conventional chain.

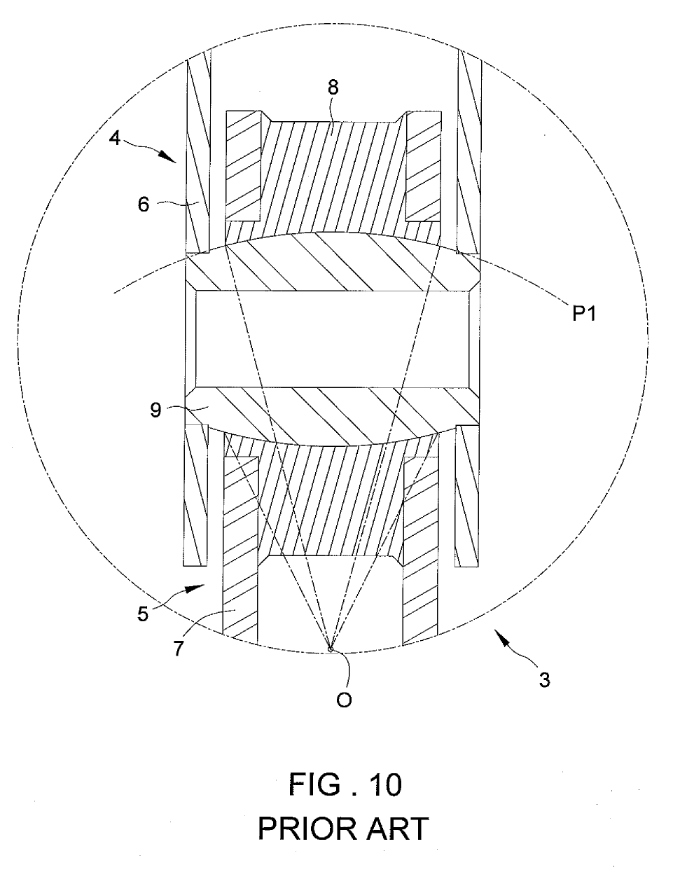

FIGS. 10 and 11 are cross-sectional views of another conventional chain.

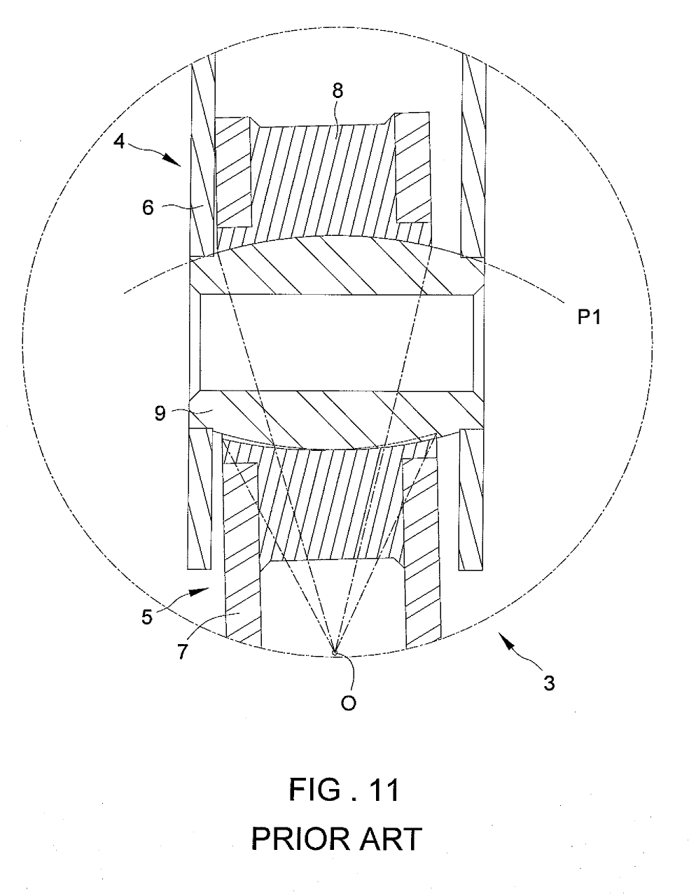

### DETAIL DESCRIPTION OF THE PREFERRED EMBODIMENT

Referring to the drawings, a chain 10 in accordance with the present invention is adapted to be used in connection with a bicycle and is configured to minimize deflecting movement occurred when shifting form one sprocket 40 of the bicycle to another.

The chain 10 includes a plurality of inner links 20 in which adjacent two are connected by an outer link 30. Each inner link 20 includes two inner plates 21 being arranged oppositely, and with their first sides facing each other. Each inner plate 21 further includes a second side being substantially parallel and opposite to the first side. The inner plate 21 also includes two holes 22 extending from the first side to the second side and two flanges 23 extending upwardly from the first side and encompassing the two holes 22 respectively. Each flange 23 has an enclosed annular periphery. However, each flange 23 may have an unenclosed annular periphery.

Each outer link 30 includes two outer plates 31 being arranged oppositely, and with their first sides facing each other. Additionally, the first side of each outer plate 31 interconnects one inner plate 21 of one inner link 20 to one inner plate 21 of another inner link 20 and, particularly on their second sides. Each outer plate 31 further includes a second side being substantially parallel and opposite to the first side. The outer plate 31 also includes two holes 32 extending from the first side to the second side. One hole 32 corresponds with one hole 22 of one inner link 20, while the other hole 32 corresponds with one hole 22 of another inner link 20, and with the holes 22 and 32 having their centers aligned one another.

The chain 10 further includes first 24 and second 25 bushings mounted between two opposite flanges 23. The first bushing 24 is mounted on inner peripheries of the flanges 23 and includes two ends received in two holes 22 that are encompassed by those flanges 23, respectively. The first bushing 24 also includes a hole 241 extending from the first end to the second end. The second bushing 25 includes a hole 251 having a first end receiving one flange 23 and a second end receiving another flange 23. The second bushing 25 is mounted on outer peripheries of the flanges 23. Further, the first 24 and second 25 bushings have enclosed annular peripheries.

The chain 10 further includes a roller 33 extending axially and mounted in two opposite holes 22 of the inner link 20, two opposite holes 32 of the outer link 30, and the hole 241 of the first bushing 24. The roller 33 and the outer link 30 can pivot together relative to the inner link 20. The inner 20 and outer 30 links rotate in a plane in a plane perpendicular to a longitudinal length of the roller 33, i.e. this length extends from a first end of the roller 33 which mounts in one of the two opposite holes 32 of the outer link 30 to a second end which mounts in the other of the two opposite holes 32.

In addition, each roller 33 includes an engaging section 331 which extends in a plane transverse to its longitudinal length and outwardly from and circumferentially on its outer periphery thereof. Further, the engaging section 331 extends in a curved shape with a uniform radial distance “r” with respect to a center “C” of the roller 33. A line extends longitudinally and passes through the center “C” can define a center line “C_{L}” that symmetrically divides the roller 33. Additionally, the engaging section 331 is moveably fit in a retaining section 242 of the first bushing 24. The retaining section 242 extends from an inner periphery which delimits the hole 241 of the first bushing 24. The retaining section 242 is of a curved shape which is complementary to the shape of engaging section 331. Thus, the retaining section 242 is in the shape of a recess. Moreover, the outer periphery of the roller 33 is gapped from the inner periphery of the first bushing 24 by a gap G1. The gap G1 increases in size as the inner periphery of the first bushing 24 become more separated from the outer periphery of the roller 33, and particularly, the inner periphery near the retaining section 242 is least separated from the outer periphery of the roller 33 and the inner periphery on the ends of the first bushing 24 are most separated from the outer periphery of the roller 33. The roller 33 and outer link 30 can thus tilt together relative to the inner link 20, and the center “C” is a pivot on which the inner 20 and outer 30 link 30 turn, and the gap G1 enables the inner link 20 to tilt relative to the outer link 30 with a satisfactory permissible extent.

Further, the first side of each outer plate 31 and the second side of the inner plate 21 to which the first side of the outer plate 31 connects have an overlapped region, and in this region the inner 21 and outer 31 plates are gapped by a gap G2 to provide the inner link 20 to tilt relative to the outer link 30 with a satisfactory permissible extent. The gap G2 increases in size as the first side of the outer link 30 become more separated from the second side of the inner link 20, and particularly, the first side near the roller 33 is least separated from the second side of the inner link 20 and the first side furthest from the roller 33 is most separated from the second side of the inner link 20.

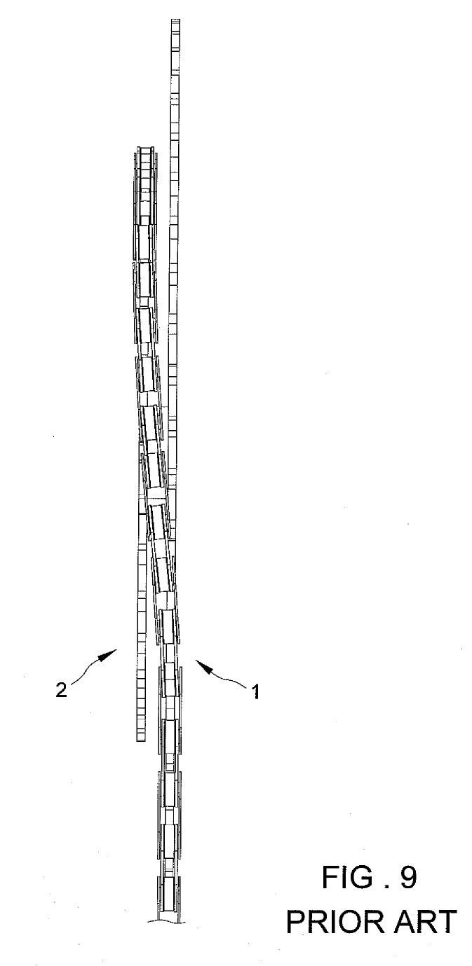

In view of forgoing, each inner link 20 and each outer link 30 connected thereto are able to tilt relative one another, and the inner 20 and outer 30 links turn with respect to the center “C” which is defined in the roller 33 which is mounted between these inner 20 and outer 30 links. Thus, the chain 10 can shift form one sprocket 40 to another with a minimized deflecting movement, as shown in FIG. 8.

While the specific embodiments have been illustrated and described, numerous modifications come to mind without significantly departing from the spirit of invention, and the scope of invention is only limited by the scope of the accompanying claims.

What is claimed is:

1. A chain comprising:
at least one inner link including two inner plates being arranged oppositely;
at least one outer link including two outer plates being arranged oppositely and sandwiching the two inner plates;
at least one first bushing mounted between the two inner plates;
at least one roller mounted in the two inner plates, two outer plates and first bushing; and
wherein the at least one roller includes an engaging section which extends in a plane transverse to its longitudinal length and outwardly from and circumferentially on its outer periphery thereof, and the engaging section extends in a curved shape with a uniform radial distance with respect to a center of the roller; and
wherein the at least one first bushing includes an inner periphery defining a retaining section in which the engaging section of the at least one roller moveably fits, and the inner periphery is gapped from the outer periphery of the roller by a first gap so that the at least one roller and the at least one outer link are able to tilt together relative to the at least one inner link, and with the center being a pivot on which the inner and outer link turn.

2. The chain as claimed in claim 1 wherein first gap has an increased size, and the inner periphery near the retaining section is least separated from the outer periphery of the roller, and the inner periphery on the ends of the first bushing are most separated from the outer periphery of the roller.

3. The chain as claimed in claim 2 wherein each outer plate of the at least one outer link and each inner plate of the at least one inner link have an overlapped region, and the inner and outer plates are gapped by a gap in this region.

4. The chain as claimed in claim 3 wherein the second gap has an increased size, and each outer plate is least separated from each inner plate in a region that is adjacent to the roller, and each outer plate is most separated from each inner plate in a region that is furthest from the roller.

5. The chain as claimed in claim 1 wherein the retaining section of the at least one first bushing is of a curved shape which is complementary to the shape of engaging section.

6. The chain as claimed in claim 1 wherein each inner plates of the at least one inner link includes a flange extending upwardly from a first side thereof, and the flanges of the two inner plates are received by a second bushing, and the second bushing includes a hole having a first end receiving an outer periphery of one flange and a second end receiving an outer periphery of another flange.

7. The chain as claimed in claim 6 wherein the at least one first bushing is mounted on inner peripheries of the flanges and includes two ends received in two holes that are encompassed by those flanges, respectively, and one hole is defined in one inner plate of the at least one inner link and another hole is defined in the other inner plate.

8. The chain as claimed in claim 6 wherein each flange has an enclosed annular periphery.

9. The chain as claimed in claim 6 wherein each flange has an unenclosed annular periphery.

10. The chain as claimed in claim 1 wherein the at least one first bushings has an enclosed annular periphery.

11. The chain as claimed in claim 6 wherein the second bushing has an enclosed annular periphery.

12. The chain as claimed in claim 1 wherein the roller and the outer link are pivot relative to the inner link, and the inner and outer links are rotatable in a plane perpendicular to the longitudinal length of the roller.
